(19) United States
(12) Patent Application Publication
(10) Pub. No.: US 2026/0328538 A1
(43) Pub. Date: Oct. 22, 2026

(54) ADAPTIVE MULTI-SPECTRUM EMISSIVITY-CONTROL COATING SYSTEM FOR THERMAL SIGNATURE AND SPECTRAL MANAGEMENT

(71) Applicant: SunInLyf Bio Inc., Sleepy Hollow, IL (US)

(72) Inventors: Mike MISKIN, Sleepy Hollow, IL (US); Charles F. HUBER, Lake Forest, IL (US)

(21) Appl. No.: 19/555,542

(22) Filed: Mar. 3, 2026

Related U.S. Application Data
(60) Provisional application No. 63/766,109, filed on Mar. 3, 2025.

(51) Int. Cl. F41H 3/00; C09D 5/30; G05B 13/02

(52) U.S. Cl. CPC F41H 3/00; C09D 5/30; G05B 13/028

(57) ABSTRACT

An adaptive multi-spectrum emissivity-control coating system for thermal signature and spectral management is disclosed. In an example, an adaptive coating system is configured to selectively manage electromagnetic radiation across multiple spectral regions, including visible, infrared (IR), and other wavelength bands. The coating system is configured to provide controllable spectral absorption, reflection, transmission, and emissivity characteristics while maintaining compatibility with a wide range of substrates and application environments.

This application claims the benefit of U.S. Provisional Application No. 63/766,109, filed Mar. 3, 2025, the entire contents of which are hereby incorporated by reference in their entirety

### TECHNICAL FIELD

This disclosure relates to adaptive surface coatings and spectral management systems. More specifically, the disclosure relates to water-based and solvent-based coatings, paints, dyes, and wearable surface treatments configured to selectively absorb, reflect, and modulate electromagnetic radiation across visible, infrared (IR), and other spectral bands. In certain embodiments, the disclosure relates to multi-spectrum emissivity control coatings capable of managing optical and thermal signatures, including applications involving thermal signature reduction, infrared reflectivity control, adaptive camouflage, and dynamic spectral tuning. The disclosure further relates to coating systems incorporating photochromic, thermochromic, electrochromic, quantum dot, low-emissivity, metamaterial, and/or sensor-integrated components to enable real-time or environmentally responsive adjustment of spectral absorption, reflectivity, and emissivity characteristics. In certain embodiments, the coating system may be coupled to sensor-driven or artificial intelligence-assisted control systems configured to dynamically regulate spectral and emissivity characteristics in response to environmental or operational inputs.

### BACKGROUND

Conventional coatings, surface treatments, and/or fabric treatments used in residential, commercial, automotive, aerospace, and military applications utilize pigments such as Titanium Dioxide (TiO₂) to create a white or colored appearance by scattering all visible light wavelengths. These conventional coatings are generally static in their spectral and thermal properties. While certain coatings incorporate infrared-reflective pigments or low-emissivity materials to reduce heat absorption, these coatings do not dynamically adjust spectral absorption, reflectivity, or emissivity in response to changing environmental conditions. Existing military stealth technologies often rely on radar-absorbing materials, static camouflage patterns, or fixed emissivity surfaces. Such approaches may reduce detectability under certain conditions but lack the ability to adapt in real time to variations in ambient lighting, background temperature, thermal imaging systems, radar interrogation, or environmental changes. Thermal imaging systems commonly operate within long-wave infrared (LWIR) bands, and detectability is influenced by surface temperature and emissivity characteristics. Static coatings are limited in their ability to modulate emissivity or spectral reflectivity dynamically to reduce optical, infrared, or multi-spectrum signatures. Accordingly, there exists a need for adaptive multi-spectrum coating systems capable of selectively absorbing, reflecting, and modulating electromagnetic radiation across visible, infrared, and other spectral regions, including coatings capable of dynamic emissivity control and sensor-responsive spectral adaptation for enhanced stealth, thermal management, and signature reduction applications.

### SUMMARY

The disclosures described herein relate to adaptive coating systems configured to selectively manage electromagnetic radiation across multiple spectral regions, including visible, infrared (IR), and other wavelength bands. The coating systems are configured to provide controllable spectral absorption, reflection, transmission, and emissivity characteristics while maintaining compatibility with a wide range of substrates and application environments. Biological and/or biologically beneficial embodiments are described in connection with sensor-responsive implementations.

In certain embodiments, the coating comprises spectrally selective materials configured to modify optical and thermal properties of a surface, including regulation of reflected and emitted radiation. The coating may incorporate wavelength-selective pigments, quantum dots, low-emissivity materials, photochromic components, thermochromic materials, electrochromic elements, metamaterial structures, and/or nanostructured additives to achieve controlled spectral behavior.

In some embodiments, the coating system enables emissivity management and thermal signature modulation by selectively controlling infrared reflection and radiative emission characteristics of the coated surface. Such control may reduce detectability under optical or infrared sensing systems or improve thermal regulation performance depending on application requirements.

In certain embodiments, the coating system may provide adaptive spectral and emissivity functionality through environmentally responsive materials and/or electronically controlled components configured to adjust absorption, reflection, transmission, and radiative emission characteristics in response to detected conditions including ambient illumination, spectral distribution, temperature, thermal gradients, motion, electromagnetic signals, or other environmental inputs, wherein such adjustments may be governed by rule-based controllers, programmable logic systems, machine learning models, or artificial intelligence “AI” processing to dynamically optimize optical and thermal performance over time, including optionally in real-time or near-real-time operation.

The coating systems described herein may be applied to architectural surfaces, transportation systems, aerospace structures, wearable materials, industrial equipment, electronic devices, and other surfaces where spectral management, thermal regulation, energy efficiency, visibility control, or signature management is desired.

These adaptive multi-spectrum coating systems provide a scalable materials platform capable of passive or active spectral tuning across diverse environments while maintaining manufacturability using conventional coating processes.

One objective of the disclosure described herein is to provide an advanced coating and surface treatment platform capable of selectively controlling spectral absorption, reflection, transmission, and emissivity characteristics across visible and infrared wavelength bands.

Another objective of the disclosure described herein is to provide a coating system compatible with conventional water-based, solvent-based, epoxy, polyurethane, film, laminate, textile, and roll-to-roll manufacturing processes, enabling scalable integration into architectural, transportation, aerospace, industrial, and electronic surface applications.

Another objective of the disclosure described herein is to provide multi-layer and/or multi-material coating architectures incorporating spectrally selective pigments, low-emissivity materials, quantum dots, nanostructured additives, photoresponsive materials, thermoresponsive materials, electrochromic elements, and/or metamaterial structures to achieve tunable optical and thermal performance.

Another objective of the disclosure described herein is to provide emissivity management and thermal signature control capabilities by regulating radiative heat transfer and infrared reflectivity characteristics of coated surfaces.

Another objective of the disclosure described herein is to enable passive or active spectral adaptation through environmentally responsive materials or electronically controlled systems configured to dynamically adjust spectral performance in response to ambient conditions, sensor inputs, or external control signals.

In certain embodiments, the coating system may form part of a sensor-responsive adaptive surface configured to modify spectral absorption, reflection, transmission, and/or emissivity characteristics based on detected environmental conditions. One or more sensors may monitor parameters including ambient light intensity, spectral composition, surface temperature, thermal gradients, proximity, motion, atmospheric conditions, electromagnetic emissions, or other operational inputs.

Sensor data may be processed by a control system configured to determine an appropriate spectral or emissivity response. The control system may comprise electronic controllers, programmable logic devices, edge-computing modules, or artificial intelligence-based processing systems including machine learning or neural network architectures.

The control system may generate activation signals that adjust one or more responsive materials within the coating system, including electrochromic layers, thermally responsive materials, phase-change components, or other tunable spectral elements. Such adjustment may modify optical appearance, infrared reflectivity, or radiative emissivity characteristics of the coated surface.

Adaptive control may operate continuously, periodically, or event-driven, enabling the coating system to dynamically respond to changing environmental or operational conditions.

Another objective of the disclosure includes providing an adaptive multi-spectrum coating system incorporating one or more of photochromic, thermochromic, electrochromic, quantum dot, low-emissivity, nanostructured, and/or metamaterial-based materials configured to dynamically adjust spectral absorption, reflectivity, transmission, and emissivity characteristics in response to ambient light conditions, temperature, electrical input, or sensor-derived control signals. In certain embodiments, the coating system may provide multi-spectrum signature management across visible, infrared (IR), and electromagnetic bands, including modulation of optical appearance, infrared reflectivity, radiative heat transfer, and electromagnetic interaction characteristics. Adaptive functionality may include electronically controlled spectral switching, sensor-assisted emissivity regulation, thermal load management, and integration into surface-applied films, laminates, structural components, textiles, vehicles, aerospace structures, or wearable systems.

In certain embodiments, emissivity modulation may be implemented within one or more mid-wave infrared (MWIR) or long-wave infrared (LWIR) spectral bands commonly used in thermal imaging systems

As used herein, the terms “coating,” “coating system,” or “surface treatment” refer broadly to any applied, deposited, laminated, embedded, infused, bonded, printed, or otherwise integrated material layer or multilayer structure disposed on, within, or forming part of a substrate, including but not limited to paints, films, laminates, polymers, composite layers, adhesives, textiles, fibers, wearable materials, or structural surfaces, whether applied as a discrete layer or integrated into a bulk material.

The various structural features, material compositions, wavelength ranges, emission characteristics, encapsulation approaches, optical management structures, and application environments described herein may be implemented individually or in any combination or sub-combination, and the disclosure expressly contemplates embodiments directed to any such combinations and sub-combinations, whether or not explicitly illustrated or described in a single embodiment

While the foregoing has set forth various embodiments of the disclosure, it is to be understood that the disclosure may be embodied in other forms without departing from its spirit or essential characteristics. The present embodiments are therefore to be considered illustrative and not restrictive, and the disclosure is not to be limited to the details described herein. Numerous modifications and variations may be made without departing from the scope of the disclosure, which is defined solely by the appended claims.

Other advantages and aspects of the present disclosure will become apparent upon reading the following description of the drawings and detailed description of the invention.

### BRIEF DESCRIPTION OF THE DRAWINGS

FIG. 1 provides an example schematic drawing according to an example embodiment of the present disclosure.

### DETAILED DESCRIPTION

One embodiment of the inventions described herein are configured to but not limited to providing water-based and/or solvent-based coatings and/or wearables that selectively absorb specific spectral wavelengths of light while reflecting infrared and other selected wavelengths of light. The disclosed coating aims to provide health benefits, thermal regulation, energy efficiency, and aesthetic versatility while maintaining a white, off-white, or custom color appearance.

Another embodiment of the disclosure described herein is configured to, but not limited to, providing a water-based and/or solvent-based coating that reduces negative health effects to vision and mitochondria cells caused by certain and/or select light wavelength exposure and reflectance including but not limited to blue light typically around 450-470 nm primarily being emitted from artificial lighting sources, improving indoor visual comfort, minimizing eye strain, and supporting mitochondrial function, circadian rhythm regulation, and overall cellular health.

Another embodiment of the disclosure described herein is configured to, but not limited to, providing water-based and/or solvent-based coatings having a spectral selectivity that extends beyond blue light absorption to include customized absorption and reflection across the visible and near-infrared spectrum.

Another embodiment of the disclosure described herein is configured to, but not limited to, providing a high-performance coating designed to absorb all visible wavelengths of blue light within the range of 400-495 nm while reflecting red to near-infrared wavelengths of light within the range of 620-2500 nm, and in some cases above 2500 nm. The formulation ensures high durability, low VOC emissions, and non-toxicity while maintaining ease of application with a roller, spray, or electrostatic deposition. The coating is suitable for residential, commercial, automotive, aerospace, and industrial applications, providing visual comfort, energy efficiency, and heat management benefits

Another embodiment of the disclosure described herein is configured to, but not limited to, providing water-based and/or solvent-based coatings having a spectral selectivity that extends beyond blue light absorption to include customized absorption and reflection across the visible and near-infrared spectrum and adaptive light absorption and/or reflectance in coatings and/or applications for military-grade stealth and camouflage materials.

Another embodiment of the disclosure described herein is configured to, but not limited to, providing a multi-functional coating that selectively absorbs, reflects, and adapts to different spectral wavelengths in real time according to the light emissions of the sun at specific wavelengths of emission, the light emissions of the moon, light emissions and/or reflectance in water, and/or artificial light emissions.

Another embodiment of the disclosure described herein is configured to, but not limited to, providing multi-functional coatings with integrated photochromic, thermochromic, electrochromic, quantum dot, and/or low-emissivity materials to create a next-generation adaptive stealth paint capable of reducing optical, infrared, and thermal signatures dynamically.

Another embodiment of the disclosure described herein is configured to, but not limited to, providing a coating, coating formulations, methods, manufacturing methods and/or processes and product application methods and/or process for applying and/or integrating such coatings that selectively absorb specific spectral wavelengths while reflecting infrared and other selected wavelengths and/or providing a wearable stealth coating adaptable to multiple surfaces and fabrics, including water-based latex, oil-based, epoxy, polyurethane paints, and textile-compatible coatings.

Another embodiment of the disclosure described herein is configured to, but not limited to, providing a multi-purpose, wavelength-selective coating and/or fabric coating designed to absorb all visible wavelengths of blue light within the range of 400-495 nm, selectively manage red to near-infrared wavelengths of light within the range of 620-2500 nm, and dynamically adapt to environmental lighting conditions such that human visual and/or electronically visual, sensible and/or detectable appearance may be altered. The formulation provides high durability, low VOC emissions, and non-toxicity, while maintaining ease of application with roller, spray, or electrostatic deposition. The coating may be configured to be available in a standard blue absorption and IR reflectance coating, or in blue absorption with IR reflectance and spectral adaptive capabilities for interior and/or exterior surfaces of building, and camouflage applications for transportation vehicles for land, sea, air and/or space, robotics and/or wearables including but not limited to military wearable clothing and/or wearable equipment. Additionally, this coating provides aerospace benefits by reducing thermal load and drag in high-speed and high-altitude aircraft, improving fuel efficiency and structural integrity.

Another embodiment of the disclosure described herein is configured to comprise a multi-functional coating that selectively absorbs, reflects, and/or adapts to different spectral wavelengths in real time Selective Absorption of Targeted Wavelengths (the Visible to IR spectrum) by utilizing organic dyes or specialized pigments to remove specific wavelengths, including but not limited to blue (400 nm-495 nm), green (495 nm-570 nm), red (620 nm-750 nm), and near-infrared to IR spectrum (750 nm-2500 nm+). The coating may be configured to comprise Customizable Spectral Selectivity to control specific wavelength absorption or reflection based on environmental needs, industry applications, and stealth capabilities and/or requirements. The coating may be configured to provide and comprise Adaptive Wearable Coatings for Military Applications that can include a formulation configured to be integrated into textiles to create adaptive combat uniforms and tactical stealth gear that respond to varying lighting conditions and thermal exposure. The coating may be configured to comprise Reduction of Mitochondrial Oxidative Stress by being configured to comprise a Selective Wavelength Filtering Mechanism that reduces oxidative damage at the cellular level, helping to prevent neurological degeneration, cognitive decline, and metabolic stress. The coating may be configured to comprise Reflection of Infrared and Selected Wavelengths by being configured to comprise NIR and/or IR reflective pigments such as Titanium Dioxide (TiO₂), Aluminum Oxide (Al₂O₃), or Boron Nitride (BN) to enhance reflectivity and reduce heat absorption. The coating may be configured to comprise Applicability Across Various Paint Types & Finishes and be configured to provide and/or be compatible with matte, semi-gloss, high-gloss, satin, and textured finishes, as well as indoor and outdoor applications. The coating may be configured to comprise Low-VOC and Non-Toxic Composition for ensuring compliance with environmental and safety regulations for household, commercial, industrial, and defense applications. The coating may be configured to comprise Military-Specific Stealth Adaptation by being configured to comprise and/or incorporate dynamic spectral tuning, infrared suppression, and electrochromic adaptation for stealth vehicles, aircraft, UAVs, and personnel uniforms. The coating may be configured to selectively absorb, reflect, and/or adapt to different spectral wavelengths in real time according to environmental light emissions of the sun at specific wavelengths of emission at different times of the day under different climates and/or weather conditions, the light emissions of the moon at different times of the day under different climates and/or weather conditions, light emissions and/or reflectance in water, and/or artificial light emissions

Another embodiment of the disclosure includes providing a smart coating configured to be an adaptive stealth coating that incorporates photochromic, thermochromic, electrochromic, quantum dot, and metamaterial-based technologies to dynamically adjust its spectral absorption, reflectivity, and emissivity based on ambient light, temperature, and electrical input. The adaptive stealth coating technology is configured to comprise: Multi-Spectrum Stealth Mechanisms configured to provide optical, infrared (IR), and radar signature reduction, Real-Time Adaptation configured to adjust spectral absorption dynamically to blend with the environment, Infrared Reflectivity & Thermal Management configured to reduce heat buildup and IR detection for military and aerospace applications, Aerospace Benefits configured to enhance high-speed aircraft performance, reducing aerodynamic heating and improving fuel efficiency, Electrochromic Switching including but not limited to AI-Controlled Electrochromic Switching configured to allow real-time sensor responding control of spectral properties via low-voltage electrical activation in response to the sensor(s), Radar Cross-Section Reduction configured to comprise and/or utilize metamaterial pigments to scatter or absorb radar waves, making objects stealthier to radar detection, and/or Wearable Applications configured to comprise the adaptive stealth coating integrated into soldier uniforms and tactical gear and/or transportation vehicles to adapt to lighting conditions and reduce thermal signatures.

Another embodiment of the disclosure comprises providing a finished product configured to be semi-coated and/or substantially completely coated, infused, impregnated, and/or doped with the coating including but not limited to building materials, clothing, electronic equipment, military equipment, transportation vehicles for land, water, air and or space such as cars, trucks, tanks, ships, planes, drones, and other finished products.

The coating may be made and configured to absorb various spectral emissions including but not limited to blue light and reflect wavelengths of NIR to IR light without being adaptive to other light and may be configured to but not be limited to comprising the following recipe, technical specification and example composition for manufacturing and/or applying the coating as outlined below in items I-6 under “Example: Non-Adaptive Spectral Selective Coating Specifications and Composition A”.

### Example: Non-Adaptive Spectral Selective Coating Specifications and Composition A

### 1. General Description

A high-performance coating designed to absorb all visible blue light within the range of 400 nm-495 nm while reflecting red to near-infrared wavelengths of light with the range of 620 nm-2500 nm. The formulation ensures high durability, low VOC emissions, and non-toxicity while maintaining ease of application with a roller, spray, or electrostatic deposition. The coating is suitable for residential, commercial, automotive, aerospace, and industrial applications, providing controlled spectral management, optical filtering, energy efficiency, and heat management benefits.

### 2. Composition

### 2.1 Base Composition (For Various Coating Types)

Binder System (Variable Based on Coating Type)
   Water-Based Latex & Acrylic Coatings: Acrylic Emulsion or Styrene-Acrylic Binder
   Oil-Based & Alkyd Coatings: Alkyd-Modified Acrylic or Waterborne Alkyd Binder
   Epoxy-Based Coatings: Epoxy-Modified Acrylic or Epoxy Resin
   Polyurethane & Urethane Coatings: Acrylic-Polyurethane Hybrid Binder
   High-Temperature & Specialty Coatings: Silicone-Modified Acrylic Binder
   % Content: 40-50% (by weight)
   Function: Provides durability, adhesion, and flexibility across all coating types

### 2.2 Functional Additives

### Selective Light-Absorbing Pigments

Blue Light Absorbing Dyes (3-5%)—Designed to selectively absorb light between 400-495 nm to control spectral reflectance characteristics.
Organic and Synthetic Absorbers-Utilized to enhance wavelength-selective filtering and spectral tuning performance.

### Near-Infrared (NIR) Reflective Pigments

Example: Titanium Dioxide (TiO₂), Aluminum Oxide (Al₂O₃), or Boron Nitride (BN)
Function: Enhances red and infrared reflectivity while maintaining a neutral or warm color appearance.

### Nanoparticles (Optional, Cost-Dependent)

Silica-based nanostructures: for enhanced red and infrared light scattering.
Quantum dots: for precise wavelength tuning.

### Dispersants & Surfactants

Ensures uniform pigment distribution.
Example: Non-ionic surfactants such as polyacrylic acid.

### Matting Agents

Reduces gloss and provides a smooth matte finish.
Example: Silica microparticles or wax-based additives.

### Biocides & Preservatives

Maintains shelf stability and prevents microbial growth.
Example: Low-toxicity, water-soluble preservatives such as isothiazolinones (BIT/MIT blend).

### 3. Physical & Optical Properties

| | |
|---|---|
| Property | Specification |

| Color Appearance | Light neutral, customizable | |
|---|---|---|
| Light Absorption | 400-495 | nm (blue) |
| Light Reflection | 620 nm-2500 nm (red & IR) | |
| Gloss Level | Matte (5-10 GU @ 60° angle) | |
| Density | ~1.2-1.4 | g/cm³ |
| VOC Content | ≤5 g/L (Ultra-low VOC) | |
| Drying Time (Touch) | 30-60 | minutes |
| Drying Time (Cure) | 24 | hours |

| | |
|---|---|
| Application Method | Roller, spray, electrostatic deposition |
| Durability | Similar to standard commercial coatings |

### 4. Performance & Durability

Weather Resistance—Comparable to standard commercial-grade exterior coatings.
UV Stability-UV—resistant additives prevent degradation.
Washability & Stain Resistance—Moderate, compatible with mild detergents.
Chemical Resistance—Resists mild acids and alkalis.
Adhesion & Flexibility—Strong adhesion to drywall, wood, masonry, metal, and plastic.
Heat Management—Reduces heat absorption by reflecting infrared wavelengths, improving thermal regulation and surface energy performance.

### 5. Safety & Environmental Compliance

VOC Content—Ultra-low VOC (≤5 g/L).
Toxicity-Non-toxic, free from heavy metals & hazardous solvents.
Fire Resistance—Not required.
Regulatory Compliance—Meets EPA, REACH, and ASTM D4236 (safe for household use).

### 6. Packaging & Storage.

Packaging—Available in all commercial and industrial use packaging.
Shelf Life—12-24 months when stored in a cool, dry place.
Storage Conditions—Avoid extreme heat/cold; store between 5-30° C. (41-86° F.).

This example formulation as described above under “Example: Non-Adaptive Spectral Selective Coating Specifications and Composition A” provides selective spectral absorption and infrared reflectivity to enable controlled optical filtering, surface spectral management, and thermal regulation. Unlike conventional coatings, this solution provides engineered wavelength-selective reflectance and emissivity characteristics while maintaining compatibility with standard coating manufacturing and application processes.

The coating configured to be adaptive to various spectral emissions while also being configured to optionally absorb various spectral emissions including but not limited to blue light and reflect wavelengths of NIR to IR light may be configured to but not be limited to comprising the following recipe, technical specification and example composition for manufacturing and/or applying the coating as outlined below in items I-4 under “Example: Adaptive Spectral Selective Coating Specifications and Composition B”.

### Example: Adaptive Spectral Selective Coating Specifications and Composition B

### 1. General Description

A multi-purpose, wavelength-selective coating and fabric coating designed to absorb all visible blue light within the range of 400 nm-495 nm), selectively manage reflection levels of red to near-infrared wavelengths of light within the range of 620 nm-2500 nm, and dynamically adapt to environmental lighting conditions such that human visual and/or electronically visual, sensible and/or detectable appearance may be altered. The formulation provides high durability, low VOC emissions, and non-toxicity, while maintaining ease of application with roller, spray, or electrostatic deposition. Available for standard coating coatings and adaptive wearable camouflage applications. Additionally, this coating provides enhanced health by reducing and/or eliminating blue light reflection from artificial light sources, reduces eye strain, aerospace benefits by reducing thermal load and drag in high-speed and high-altitude aircraft, improving fuel efficiency and structural integrity.

### 2. Composition

2.1 Base Composition (For coating & Textile Coating)
Binder System (Variable Based on coating Type)
   Water-Based Latex & Acrylic coatings: Acrylic Emulsion or Styrene-Acrylic Binder
   Oil-Based & Alkyd coatings: Alkyd-Modified Acrylic or Waterborne Alkyd Binder
   Epoxy-Based Coatings: Epoxy-Modified Acrylic or Epoxy Resin
   Polyurethane & Urethane Coatings: Acrylic-Polyurethane Hybrid Binder
   High-Temperature & Specialty Coatings: Silicone-Modified Acrylic Binder 0% Content: 40-50% (by weight)
   Function: Provides durability, adhesion, and flexibility across all coating types

### 2.2 Functional Additives

### Selective Light-Absorbing & Adaptive Pigments

Photochromic Dyes (3-5%)—Adjust visible light absorption dynamically to match environmental conditions.
Thermochromic Pigments (2-4%)—Alters spectral absorption properties based on temperature shifts.
Quantum Dots (1-3%)—Provides tunable spectral absorption across blue (400-495 nm), green (495-570 nm), red (620-750 nm), and near-infrared (750-2500 nm).

### Near-Infrared (NIR) Reflective Pigments

Example: Titanium Dioxide (TiO₂), Aluminum Oxide (Al₂O₃), or Boron Nitride (BN)
Function: Enhances red and infrared reflectivity while maintaining a neutral or warm color appearance

### Infrared & Thermal Signature Reduction Components

Infrared-Reflective Pigments (5-10%)—Includes Boron Nitride (BN), Aluminum Oxide (Al₂O₃), and Titanium Dioxide (TiO₂) to minimize infrared detection.
Low-Emissivity Coatings (2-6%)—Reduces heat radiation to suppress infrared detectability under thermal imaging systems.
Graphene-Based Conductive Fibers (1-3%)—Distributes thermal energy efficiently, reducing local hotspots that may be detected by infrared sensors.
Aerospace Heat Shielding Pigments (2-5%)—Reduces frictional heating and drag at high altitudes and supersonic speeds, improving fuel efficiency and thermal management.

### Nanoparticles (Optional, Cost-Dependent)

Silica-based nanostructures for enhanced scattering of red and infrared light
Quantum dots for precise wavelength tuning

### Adaptive Camouflage & Stealth Enhancement (Wearable Coating Only)

Electrochromic Nanoparticles (3-7%)—Enables dynamic color and reflectivity changes in response to an electrical charge.
Phase-Change Materials (PCMs) (2-5%)—Modulates thermal emissivity to match surrounding temperature.
Metamaterial-Based Pigments (2-4%)—Alters reflection properties based on ambient light and sensor-based stimulus.
Conductive Polymer Matrix (2-6%)—Facilitates activation of dynamic spectral tuning when connected to a low-voltage power source.
AI-Controlled Electrochromic Switching-Provides real-time control of spectral properties via low-voltage electrical activation in response to sensors

### Dispersants & Surfactants

Ensures uniform pigment distribution
Example: Non-ionic surfactants such as polyacrylic acid

### Matting Agents

Reduces gloss and provides a smooth matte finish
Example: Silica microparticles or wax-based additives

### Biocides & Preservatives

Maintains shelf stability and prevents microbial growth
Example: Low-toxicity, water-soluble preservatives such as isothiazolinones (BIT/MIT blend)

### 3. Physical & Optical Properties

| Property | Specification | |
|---|---|---|
| Color Appearance | Light neutral, customizable | |
| Light Absorption | 400-495 nm (blue), adaptable spectral tuning | |
| Light Reflection | 620 nm-2500 nm (red & IR) | |
| Gloss Level | Matte (5-10 GU @ 60° angle) | |
| Density | ~1.2-1.4 | g/cm³ |
| VOC Content | ≤5 g/L (Ultra-low VOC) | |
| Drying Time | 30-60 | minutes |
| (Touch) | | |
| Drying Time (Cure) | 24 | hours |

| | |
|---|---|
| Application Method | Roller, spray, electrostatic deposition (for fabric) |
| Durability | Similar to standard commercial latex coatings |
| Aerospace Benefits | Reduced heat load, lower aerodynamic drag, |
| | fuel efficiency optimization |

### 4. Performance & Durability

Weather Resistance-Comparable to standard commercial-grade exterior latex coatings.
UV Stability-UV-resistant additives prevent degradation.
Washability & Stain Resistance-Moderate, compatible with mild detergents.
Chemical Resistance-Resists mild acids and alkalis.
Adhesion & Flexibility-Strong adhesion to standard surfaces (drywall, wood, masonry) & flexible textiles.
Stealth Capabilities-Adaptive spectral absorption and IR suppression for wearable military applications and military vehicles.
Aerospace Performance-Improves thermal shielding for high-speed aircraft, reduces frictional heat and drag, and enhances operational efficiency in high-altitude environments.

This example formulation as described above under “Example: Adaptive Spectral Selective Coating Specifications and Composition B” provides adaptive spectral absorption, infrared suppression, and military-grade stealth capabilities, while allowing binder flexibility for multiple coating and coating types. Additionally, its aerospace properties enhance fuel efficiency, reduce aerodynamic heating, and improve high-speed aircraft durability. It ensures broad civilian applications while keeping advanced stealth implementation classified for military use.

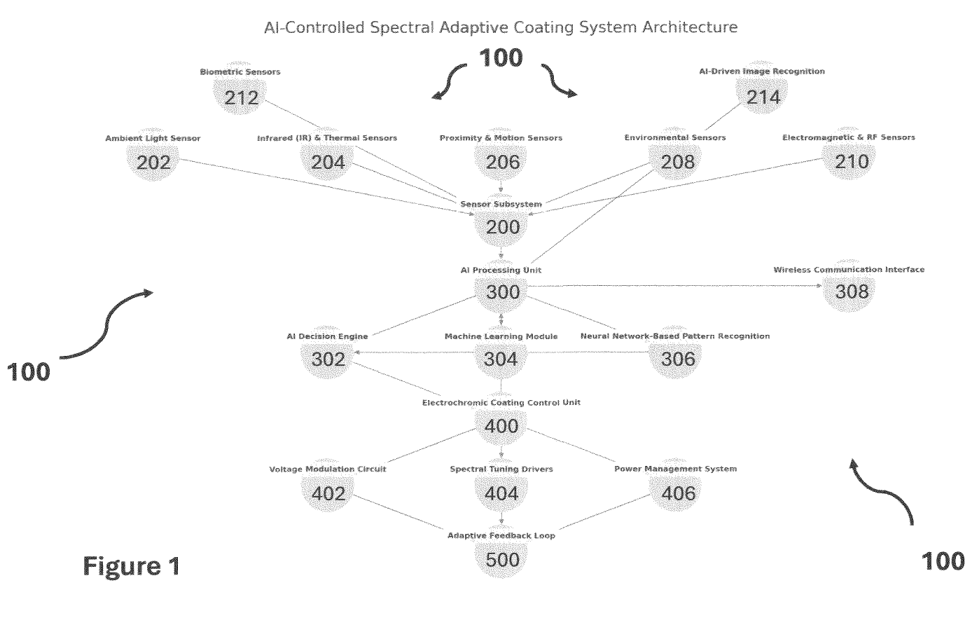

FIG. 1 illustrates one non-limiting example embodiment of an adaptive coating system incorporating sensor-responsive and AI-assisted control features, it being understood that such control architectures are optional and that the coating system may operate in passive, environmentally responsive, or electronically controlled modes without artificial intelligence integration.

FIG. 1 shows and describes an example embodiment according to the disclosure being configured to comprise an AI-controlled spectral adaptive coating system 100 configured to operate and/or control the coating 102 by integrating real-time environmental and biometric sensor data to dynamically adjust the electrochromic spectral properties of the coating 102 when the coating is integrated within and/or applied to a device. In this illustrated embodiment, spectral adaptive coating system 100 comprises an AI-assisted spectral adaptive coating control architecture to optimize visibility, thermal regulation, and stealth characteristics across various applications, such as wearables, tactical equipment, vehicles, and smart surfaces. The AI-controlled spectral adaptive coating system 100 architecture begins with a multi-sensor subsystem 200 that collects external and internal environmental data. Thie multi-sensor subsystem 200 is configured to include but not be limited to at least one Ambient Light Sensor(s) 202 configured to detect natural and artificial light sources to determine optimal spectral tuning for visibility enhancement or glare reduction, at least one of a Infrared (IR) and/or Thermal Sensor(s) 204 configured to measure surrounding heat levels to adjust IR reflection and emissivity to optimize thermal management and stealth characteristics, at least one of a Proximity and/or Motion Sensor(s) 206 configured to detect movement and surrounding objects to enable dynamic adaptation of reflectivity or camouflage, at least one Environmental Sensor(s) 208 configured to assess humidity, air quality, and radiation exposure to ensure the coating 102 remains effective in various conditions, at least one of a Electromagnetic and/or RF Sensor(s) 210 configured to identify radar and/or LiDAR signals and adjust the coating's 102 properties for stealth applications in military and aerospace environments, at least one Biometric Sensor(s) 212 configured to monitor physiological conditions such as heart rate, body temperature, and sweat levels of a person, enabling sensor-driven adaptive regulation of surface optical and thermal properties in response to detected biometric or environmental inputs when the coating 102 is utilized and/or integrated on a wearable and/or tactical gear, at least one AI-Driven Image Recognition 214 configured to use computer vision to analyze the surrounding environment and background textures to intelligently blend the coating's 102 properties for adaptive camouflage. Sensor data may be transmitted to an AI Processing Unit 300 for analysis and generation of control signals. The AI Processing Unit 300 acts as the central intelligence of the system, responsible for analyzing sensor input and executing spectral adaptation strategies. The AI Processing Unit 300 comprises at least one AI Decision Engine 302 configured to use predefined rules and real-time environmental inputs to select appropriate electrochromic adjustments, at least one Machine Learning Module 304 configured to continuously improve the coating's 102 response by learning from historical sensor data, environmental changes, and user preferences, at least one Neural Network-Based Pattern Recognition 306 is configured to identify light patterns, movement trends, and environmental cues to anticipate optimal spectral tuning, at least one Wireless Communication Interface 308 is configured to provide and/or allow remote system updates, user customization, and integration with external control systems for adaptive learning and real-time AI tuning. Once the AI system determines the optimal adjustment of the coating 102, it sends activation signals to the Electrochromic Coating Control Unit 400 for Electrochromic Coating Adjustment Execution. The Electrochromic Coating Control Unit 400 directly manages the physical spectral adaptation of the coating 102 by modulating its optical and thermal properties and is configured to comprise at least one Voltage Modulation Circuit 402 configured to supply the necessary electrical input to activate spectral changes in the electrochromic layer, at least one Spectral Tuning Driver(s) 404 is configured to adjust wavelength absorption, reflection, and emissivity to optimize visibility, camouflage, or heat management, at least one Power Management System 406 is configured to ensure that energy-efficient techniques, such as photovoltaic or thermoelectric energy harvesting sustain the system's functionality without excessive power draw. A real-time adaptive feedback loop 500 monitors the effectiveness of spectral adaptations and continuously refines the performance. The AI processing unit 300 evaluates coating 102 performance based on Immediate sensor re-evaluation to confirm desired optical/thermal changes, Adaptive Corrections for environmental fluctuations and Long-term Learning from historical data trends to enhance spectral tuning efficiency over time. The adaptive feedback loop 500 ensures the coating 102 maintains optimal functionality even in dynamic environments, such as rapid temperature changes, shifting lighting conditions, or tactical stealth scenarios. In certain embodiments involving human-occupied or biologically sensitive environments, the multi-sensor subsystem 200 may include biometric or environmental monitoring inputs to enable adaptive regulation of spectral or thermal surface characteristics

The below outline of items 1-5 entitled “EXAMPLE: System Architecture for AI-Controlled Spectral Adaptive Coating with Electrochromic Switching 100” provides another detailed explanation in outline form of an example AI-controlled spectral adaptive coating system similar to the AI-controlled spectral adaptive coating system 100 as described above in FIG. 1.

### EXAMPLE: System Architecture for AI-Controlled Spectral Adaptive Coating with Electrochromic Switching 100

### Detailed Explanation of AI-Controlled Spectral Adaptive Coating System Architecture

The AI-controlled spectral adaptive coating system 100 operates by integrating real-time environmental and biometric sensor data to dynamically adjust the electrochromic coating's 102 spectral properties. The AI-controlled spectral adaptive coating system 100 is designed to optimize visibility, thermal regulation, and stealth characteristics across various applications, such as wearables, vehicles, tactical equipment and smart surfaces.

### 1. Sensor Data Collection and Input Processing

The AI-controlled spectral adaptive coating system 100 architecture begins with a multi-sensor subsystem 200 that collects external and internal environmental data. This includes:
Ambient Light Sensors 202: Detect natural and artificial light sources to determine optimal spectral tuning for visibility enhancement or glare reduction.
Infrared (IR) & Thermal Sensors 204: Measure surrounding heat levels to adjust IR reflection and emissivity, optimizing thermal management and stealth characteristics.
Proximity & Motion Sensors 206: Detect movement and surrounding objects, enabling dynamic adaptation of reflectivity or camouflage.
Environmental Sensors 208: Assess humidity, air quality, and radiation exposure, ensuring the coating remains effective in various conditions.
Electromagnetic & RF Sensors 210: Identify radar and LiDAR signals and adjust the coating's properties for stealth applications in military and aerospace environments.
Biometric Sensors (Wearables Only) 212: Monitor physiological conditions such as heart rate, body temperature, and sweat levels, enabling personalized thermal regulation and comfort optimization.
AI-Driven Image Recognition 214: Uses computer vision to analyze the surrounding environment and background textures to intelligently blend the coating's properties for adaptive camouflage.

All collected sensor data is sent to the AI Processing Unit 300 in real-time.

### 2. AI Processing and Decision Engine

The AI Processing Unit 300 acts as the central intelligence of the system, responsible for analyzing sensor input and executing spectral adaptation strategies. This unit comprises:
AI Decision Engine 302: Uses predefined rules and real-time environmental inputs to select appropriate electrochromic adjustments.
Machine Learning Module 304: Continuously improves coating responses by learning from historical sensor data, environmental changes, and user preferences.
Neural Network-Based Pattern Recognition 306: Identifies light patterns, movement trends, and environmental cues to anticipate optimal spectral tuning.
Wireless Communication Interface 308: Allows remote system updates, user customization, and integration with external control systems for adaptive learning and real-time AI tuning.

Once the AI system determines the optimal coating adjustment, it sends activation signals to the Electrochromic Coating Control Unit 400.

### 3. Electrochromic Coating Adjustment Execution

The Electrochromic Coating Control Unit 400 directly manages the physical spectral adaptation of the coating by modulating its optical and thermal properties. It consists of:
Voltage Modulation Circuit 402: Supplies the necessary electrical input to activate spectral changes in the electrochromic layer.
Spectral Tuning Drivers 404: Adjust wavelength absorption, reflection, and emissivity to optimize visibility, camouflage, or heat management.
Power Management System 406: Ensures that energy-efficient techniques, such as photovoltaic or thermoelectric energy harvesting, sustain the system's functionality without excessive power draw.

### 4. Adaptive Feedback Loop 500 for Continuous Optimization

A real-time adaptive feedback loop 500 monitors the effectiveness of spectral adaptations and continuously refines the system's performance. The AI processing unit evaluates coating performance based on:
Immediate sensor re-evaluation to confirm desired optical/thermal changes.
Adaptive corrections for environmental fluctuations.
Long-term learning from historical data trends to enhance spectral tuning efficiency over time.

The adaptive feedback loop 500 ensures the coating maintains optimal functionality even in dynamic environments, such as rapid temperature changes, shifting lighting conditions, or tactical stealth scenarios.

### 5. Applications of the AI-Driven Adaptive Coating System

This system can be utilized across multiple industries, including:
Military Vehicles & Aerospace: IR signature control and radar reflection adaptation for stealth technology.
Wearables: Personalized temperature control and adaptive camouflage for military, sports, and medical applications.
Automotive & Smart Glass: Intelligent glare reduction, heat reflection, and night-time visibility enhancements.
Architectural Smart Surfaces: Adaptive windows that optimize light transmission and thermal insulation for energy efficiency.

This AI-driven spectral adaptive coating system 100 as described above provides a cutting-edge integration of electrochromic materials, real-time sensor networks, and AI intelligence, enabling unmatched flexibility, efficiency, and adaptability in dynamic environments. Its ability to respond to environmental inputs, optimize spectral properties, and learn from user behavior makes it a revolutionary advancement in smart coatings and surface technologies.

The below outline of items I-4 entitled “EXAMPLE: System Architecture for AI-Controlled Spectral Adaptive Coating with Electrochromic Switching D” provides another example of an AI-controlled spectral adaptive coating system similar to the AI-controlled spectral adaptive coating system 100 as described above in FIG. 1.

### EXAMPLE: System Architecture for AI-Controlled Spectral Adaptive Coating with Electrochromic Switching D

### 1. Overview

One example embodiment of the disclosure comprises an AI-controlled spectral adaptive coating that integrates electrochromic switching, multi-sensor data acquisition, and machine learning algorithms to dynamically adjust spectral properties for wearables, tactical equipment, vehicles, and smart surfaces. The system continuously monitors environmental and biometric data to optimize absorption, reflection, and emissivity for specific use cases, such as stealth, thermal regulation, and visibility control.

### 2. System Components

### 2.1 Sensor Subsystem

A network of real-time sensors provides input data to the AI processing unit:
Ambient Light Sensor: Measures visible light intensity and spectral distribution.
Infrared (IR) & Thermal Sensors: Detects surrounding heat levels and adjusts IR reflectivity/emissivity accordingly.
Proximity & Motion Sensors: Monitors user movement and adjusts coating for dynamic reflectivity.
Environmental Sensors: Detects air quality, humidity, and radiation for adaptive protection.
Electromagnetic & RF Sensors: Identifies radar/LiDAR signals for adaptive stealth response.
Biometric Sensors (Wearables Only): Monitors body temperature, heart rate, and other physiological indicators to optimize thermal comfort.
AI-Driven Image Recognition: Analyzes the surrounding visual environment for adaptive camouflage and visibility control.

### 2.2 AI Processing Unit

AI Decision Engine: Processes real-time sensor data and executes dynamic spectral adjustments.
Machine Learning Module: Adapts to user behavior, environmental trends, and historical patterns to improve spectral tuning.
Neural Network-Based Pattern Recognition: Detects patterns in light conditions, movement, or external threats and adjusts coating responses accordingly.
Wireless Communication Interface: Enables remote AI learning updates and user customization via cloud or edge computing.

### 2.3 Electrochromic Coating Control Unit

Voltage Modulation Circuit: Adjusts electrochromic layer properties based on AI instructions.
Spectral Tuning Drivers: Controls absorption, reflection, and emissivity in visible, infrared, and ultraviolet wavelengths.
Power Management System: Uses photovoltaic or thermoelectric energy harvesting for sustainable operation.

### 3. System Operation Flow

### 3.1 Sensor Data Collection:

The sensors continuously monitor the surrounding environment and user conditions.
Data is sent to the AI Processing Unit in real-time.

### 3.2 AI Decision Processing:

The AI system analyzes sensor input and applies pre-trained models and real-time machine learning.
Determines the optimal spectral response for the given conditions (e.g., adaptive camouflage, heat dissipation, visibility enhancement).

### 3.3 Electrochromic Adjustment Execution:

AI sends control signals to the electrochromic coating control unit.
Voltage adjustments modulate coating properties (e.g., darkening, IR reflection, emissivity changes).

### 3.4 Adaptive Feedback Loop:

AI continuously monitors the effectiveness of the adjustment.
The system fine-tunes parameters based on historical data and real-time feedback.

### 4. Applications & Use Cases

Wearables: Real-time body temperature regulation & adaptive camouflage.
Military Vehicles: Adaptive stealth by adjusting IR and radar reflectivity.
Smart Buildings: AI-controlled windows optimizing light transmission & heat retention.
Aerospace & Automotive: Dynamic reflectivity control for aerodynamic efficiency & stealth.

The above outline of System Architecture for AI-Controlled Spectral Adaptive Coating with Electrochromic Switching C further describes an AI-driven, sensor-integrated electrochromic adaptive coating capable of dynamic spectral tuning based on real-time conditions. The fusion of AI, machine learning, and multi-sensor data processing ensures high adaptability and efficiency across wearables, tactical equipment, vehicles, and smart surfaces.

While the foregoing there has set forth embodiments of the disclosure, it is to be understood that the present disclosure may be embodied in other forms without departing from the spirit or central characteristics thereof. The present embodiments, therefore, are to be considered in all respects as illustrative and not restrictive, and the disclosure is not to be limited to the details given herein. While specific embodiments have been illustrated and described, numerous modifications come to mind without significantly departing from the characteristics of the disclosure and the scope of protection is only limited by the scope of the accompanying claims.

The invention is claimed as follows:

1. A coating system comprising:
at least one spectrally selective material configured to control at least one of absorption, reflection, transmission, or emissivity of electromagnetic radiation across at least a visible wavelength band and at least one infrared wavelength band when applied to a substrate.

2. The coating system of claim 1, wherein the at least one infrared wavelength band comprises at least one of a mid-wave infrared (MWIR) band or a long-wave infrared (LWIR) band.

3. The coating system of claim 1, wherein the at least one spectrally selective material comprises at least one of a low-emissivity material, quantum dot, photochromic material, thermochromic material, electrochromic material, nanostructured additive, metamaterial structure, or wavelength-selective pigment.

4. The coating system of claim 1, wherein the coating system is configured to reduce thermal signature detectability under infrared sensing systems.

5. The coating system of claim 1, wherein emissivity characteristics are selectively modulated to regulate radiative heat transfer from the substrate.

6. The coating system of claim 1, wherein the coating system comprises a multilayer architecture including at least one emissivity-modulating layer and at least one spectrally selective layer.

7. The coating system of claim 1, wherein the coating system is compatible with at least one of water-based, solvent-based, epoxy, polyurethane, textile, laminate, or roll-to-roll manufacturing processes.

8. The coating system of claim 1, wherein the coating system is configured to operate in a passive mode without electronic control.

9. The coating system of claim 1, wherein the at least one spectrally selective material comprises metamaterial-based pigments configured to modify electromagnetic interaction characteristics.

10. The coating system of claim 1, wherein the coating system is configured to regulate surface thermal load for energy efficiency optimization.

11. A finished article comprising a substrate and the coating system of claim 1 disposed on or integrated within the substrate.

12. The finished article of claim 11, wherein the substrate comprises at least one of a land vehicle, marine vessel, aircraft, unmanned aerial vehicle, structural panel, wearable textile, architectural surface, or industrial equipment.

13. A sensor-responsive adaptive coating system comprising:
a coating including at least one spectrally selective material configured to modulate emissivity and spectral reflectivity;
at least one sensor configured to detect environmental or operational conditions; and
a control unit configured to adjust at least one optical or thermal characteristic of the coating based on sensor input.

14. The sensor-responsive adaptive coating system of claim 13, wherein the environmental or operational conditions comprise at least one of ambient light intensity, spectral composition, surface temperature, thermal gradient, proximity, motion, atmospheric condition, electromagnetic signal, or vehicle operating state.

15. The sensor-responsive adaptive coating system of claim 13, wherein the at least one optical or thermal characteristic comprises emissivity within at least one infrared band used in thermal imaging systems.

16. The sensor-responsive adaptive coating system of claim 13, wherein the control unit is configured to regulate radiative heat transfer for thermal management.

17. The sensor-responsive adaptive coating system of claim 13, wherein the sensor-responsive adaptive coating system is configured to optimize surface temperature regulation of an electric vehicle battery enclosure or vehicle body panel.

18. The sensor-responsive adaptive coating system of claim 13, wherein the sensor-responsive adaptive coating system is configured to interface with at least one vehicle control system, battery management system, or building automation system.

19. The sensor-responsive adaptive coating system of claim 13, wherein the control unit comprises an artificial intelligence-assisted processing architecture.

20. The sensor-responsive adaptive coating system of claim 19, wherein the artificial intelligence-assisted processing architecture comprises at least one of a machine learning module, neural network module, or rule-based decision engine.

21. The sensor-responsive adaptive coating system of claim 19, wherein the sensor-responsive adaptive coating system further comprises a feedback loop configured to refine spectral adjustments based on sensor re-evaluation.

22. The sensor-responsive adaptive coating system of claim 13, further comprising an electrochromic layer configured to modify spectral properties in response to an electrical input.

23. The sensor-responsive adaptive coating system of claim 13, further comprising a phase-change material configured to modulate emissivity based on temperature conditions.

24. The sensor-responsive adaptive coating system of claim 13, further comprising a power management system configured to support adaptive operation using at least one of photovoltaic or thermoelectric energy harvesting.

25. The sensor-responsive adaptive coating system of claim 13, wherein the sensor-responsive adaptive coating system is configured to reduce multi-spectrum detectability including visible, infrared, and radar signatures.

26. The sensor-responsive adaptive coating system of claim 13, wherein the sensor-responsive adaptive coating system is configured to operate in real-time or near-real-time adaptive mode.

27. A finished article comprising a substrate and the sensor-responsive adaptive coating system of claim 13 disposed on or integrated within the substrate.

28. The finished article of claim 27, wherein the substrate comprises at least one of an electric vehicle body panel, battery enclosure, aerospace structure, unmanned system, robotic platform, architectural façade, or smart building component.

29. The finished article of claim 27, wherein the sensor-responsive adaptive coating system is configured to dynamically regulate thermal load or spectral signature of the finished article.

30. The finished article of claim 27, wherein the sensor-responsive adaptive coating system is configured to interface with an external control network for coordinated surface optimization.
